(19) United States
(12) Patent Application Publication
(10) Pub. No.: US 2022/0336846 A1
(43) Pub. Date: Oct. 20, 2022

(54) METHODS FOR FORMING SOLID-STATE ELECTROLYTE LAYERS

(71) Applicant: GM GLOBAL TECHNOLOGY OPERATIONS LLC, Detroit, MI (US)

(72) Inventors: Xingcheng XIAO, Troy, MI (US); Hongliang WANG, Sterling Heights, MI (US)

(73) Assignee: GM GLOBAL TECHNOLOGY OPERATIONS LLC, Detroit, MI (US)

(21) Appl. No.: 17/230,800

(22) Filed: Apr. 14, 2021

(51) Int. Cl. H01M 10/0562; H01M 10/54

(52) U.S. Cl. CPC H01M 10/0562; H01M 10/54; H01M 2300/0071

(57) ABSTRACT

A method for restoring a solid-state electrolyte layer having passivation layers formed on one or more surfaces thereof is provided. The method includes exposing one or more surface regions of the solid-state electrolyte layer by removing the passivation layers using a surface treatment process. The surface treatment process may include heating at least one portion of the passivation layers or an interface between the solid-state electrolyte layer and the passivation layers to a temperature that is at least 5% greater than a decomposition temperature of the passivation layers. The surface treatment process may use be a laser surface treatment process or a plasma surface treatment process. In each instance, the surface treatment process may be a thermal vaporization process and/or may cause volumetric expansion of the passivation layers and/or may cause thermal stress at an interface between the solid-state electrolyte layer and the passivation layers.

### GOVERNMENT FUNDING

This invention was made with government support under Agreement No. DE-EE-0008863 awarded by the Department of Energy. The Government may have certain rights in the invention.

### INTRODUCTION

This section provides background information related to the present disclosure which is not necessarily prior art.

Electrochemical energy storage devices, such as lithium-ion batteries, can be used in a variety of products, including automotive products such as start-stop systems (e.g., 12V start-stop systems), battery-assisted systems (“μBAS”), Hybrid Electric Vehicles (“HEVs”), and Electric Vehicles (“EVs”). Typical lithium-ion batteries include two electrodes and an electrolyte component and/or separator. One of the two electrodes can serve as a positive electrode or cathode, and the other electrode can serve as a negative electrode or anode. Lithium-ion batteries may also include various terminal and packaging materials. Rechargeable lithium-ion batteries operate by reversibly passing lithium ions back and forth between the negative electrode and the positive electrode. For example, lithium ions may move from the positive electrode to the negative electrode during charging of the battery and in the opposite direction when discharging the battery. A separator and/or electrolyte may be disposed between the negative and positive electrodes. The electrolyte is suitable for conducting lithium ions between the electrodes and, like the two electrodes, may be in a solid form, a liquid form, or a solid-liquid hybrid form. In the instances of solid-state batteries, which include a solid-state electrolyte layer disposed between the solid-state electrodes, the solid-state electrolyte physically separates the solid-state electrodes so that a distinct separator is not required.

Solid-state batteries have advantages over batteries that include a separator and a liquid electrolyte. These advantages can include a longer shelf life with lower self-discharge, simpler thermal management, a reduced need for packaging, and the ability to operate within a wider temperature window. For example, solid-state electrolytes are generally non-volatile and non-flammable, so as to allow cells to be cycled under harsher conditions without experiencing diminished potential or thermal runaway, which can potentially occur with the use of liquid electrolytes. However, solid-state electrolytes may be air sensitive such that undesirable passivation layers form on one or more surfaces thereof, and also, solid-state batteries often have comparatively low power capabilities caused, for example, by solid-state electrolyte layer interfacial resistance caused by limited contact, or void spaces, between the solid-state electroactive particles and/or the solid-state electrolyte particles; or reactions between the solid-state electrodes and the solid-state electrolyte layer. Accordingly, it would be desirable to develop high-performance solid-state battery designs, materials, and methods that improve power capabilities, as well as energy density.

### SUMMARY

This section provides a general summary of the disclosure, and is not a comprehensive disclosure of its full scope or all of its features.

The present disclosure relates to a solid-state electrolyte layer for incorporation in a solid-state battery, and methods of forming the same.

In various aspects, the present disclosure provides, a method for restoring a solid-state electrolyte layer having one or more passivation layers formed on one or more surfaces thereof. The method may include exposing one or more surface regions of the solid-state electrolyte layer by removing the one or more passivation layers using a surface treatment process. The surface treatment process may include heating at least one portion of the one or more passivation layers or an interface between the solid-state electrolyte layer and the one or more passivation layers to a temperature that is at least 5% greater than a decomposition temperature of the one or more passivation layers.

In one aspect, the surface treatment process may be a thermal vaporization process.

In one aspect, the surface treatment process may include heating the interface between the solid-state electrolyte layer and the one or more passivation layers such that thermal stress causes the one or more passivation layers to break away from the solid-state electrolyte layer.

In one aspect, the surface treatment process may include heating the at least one portion of the one or more passivation layers so as to cause volumetric expansion of the one or more passivation layers, and the method may further include peeling the one or more passivation layers away from the one or more surface regions of the solid-state electrolyte layer.

In one aspect, the surface treatment process may use a laser scanner. The laser scanner may transmits light having a power of greater than or equal to about 300 W to less than or equal to about 1,000 W. The surface treatment process may have a scan speed for transmitting light that is greater than or equal to about 1 m/s to less than or equal to about 5 m/s.

In one aspect, the surface treatments process may have a spot size that is greater than or equal to about 100 nm to less than or equal to about 10 μm.

In one aspect, the surface treatment process may use a plasma treatment process.

In one aspect, the removing may occur in an inert atmosphere.

In one aspect, the removing may occur within a period of less than or equal to about 24 hours and occurs in an open environment.

In one aspect, the method may further include disposing a protective layer on the one or more surface regions of the solid-state electrolyte layer.

In one aspect, the protective layer may be a substantially continuous coating having a thickness of greater than or equal to about 5 nm to less than or equal to about 5 μm and an ionic conductivity of greater than or equal to about 1 S·cm⁻¹ to less than or equal to about 1×10⁻⁸ S·cm⁻¹.

In one aspect, the protective layer may include one or more materials selected from the group consisting of: gold (Au), silver (Ag), aluminum (Al), lithium phosphorus oxynitride (LiPON), lithium phosphate (Li₃PO₄), lithium nitride (Li₃N), polyethylene oxide (PEO), and combinations thereof.

In one aspect, the method may further include, prior to the exposing, sintering a plurality of solid-state electrolyte particles to form the solid-state electrolyte layer. The one or more passivation layers may be formed on the one or more surfaces of the solid-state electrolyte layer when exposed to at least one of water and carbon dioxide.

In one aspect, the one or more passivation layers may include lithium carbonate (Li₂CO₃) and the solid-state electrolyte layer may include lithium lanthanum zirconium oxide (Li₇La₃Ze₂O₁₂) (LLZO).

In various aspects, the present disclosure provides a method for forming a solid-state electrolyte layer. The method may include treating a surface of a solid-state electrolyte precursor, where the solid-state electrolyte precursor includes a solid-state electrolyte layer and one or more passivation layers formed on one or more surfaces thereof. The treating may include removing the one or more passivation layers from the solid-state electrolyte precursor to expose one or more surface regions of the solid-state electrolyte surface. The method may further include disposing a protective layer on at least one of the one or more surface regions of the solid-state electrolyte layer. The protective layer may be a substantially continuous coating having a thickness greater than or equal to about 5 nm to less than or equal to about 5 μm and an ionic conductivity greater than or equal to about 1 S·cm⁻¹ to less than or equal to about 1×10⁻⁸ S·cm⁻¹.

In one aspect, the one or more passivation layers may be removed from the solid-state electrolyte precursor by using one of a laser surface treatment process or a plasma surface treatment process. The laser surface treatment process or the plasma surface treatment process may heat at least a portion of the one or more passivation layers to a temperature that is at least 5% greater than a decomposition temperature of the one or more passivation layers.

In one aspect, the treating of the surface of the solid-state electrolyte precursor may include heating the interface between the solid-state electrolyte layer and the one or more passivation layers such that thermal stress causes the one or more passivation layers break away from the solid-state electrolyte layer.

In one aspect, the treating the surface of the solid-state electrolyte precursor may include heating at least one portion of the one or more passivation layers so to cause volumetric expansion of the one or more passivation layers, and the method may further include peeling the one or more passivation layers away from the one or more surface regions of the solid-state electrolyte layer.

In one aspect, the treating may occur in an inert atmosphere.

In one aspect, the treating may occur within a period less than or equal to about 24 hours and occurs in an open environment.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is an illustration of an example solid-state battery in accordance with various aspects of the present disclosure;

FIG. 2A is a scanning electron microscope image of a clean solid-state electrolyte layer;

FIG. 2B is a scanning electron microscope image of a solid-state electrolyte layer after exposure to the environment;

FIG. 3A is an illustration of an example method for restoring a solid-state electrolyte layer for incorporation into a solid-state battery, such as the solid-state battery illustrated in FIG. 1, in accordance with various aspects of the present disclosure;

FIG. 3B is another illustration of the example method for restoring a solid-state electrolyte layer for incorporation into a solid-state battery illustrated in FIG. 3A; and

FIG. 3C is another illustration of the example method for restoring a solid-state electrolyte layer for incorporation into a solid-state battery illustrated in FIG. 3A.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

The current technology pertains to solid-state batteries (SSBs), for example only, bipolar solid-state batteries, and methods of forming and using the same. Solid-state batteries may include at least one solid component, for example, at least one solid electrode, but may also include semi-solid or gel, liquid, or gas components, in certain variations. Solid-state batteries may have a bipolar stacking design comprising a plurality of bipolar electrodes where a first mixture of solid-state electroactive material particles (and optional solid-state electrolyte particles) is disposed on a first side of a current collector, and a second mixture of solid-state electroactive material particles (and optional solid-state electrolyte particles) is disposed on a second side of a current collector that is parallel with the first side. The first mixture may include, as the solid-state electroactive material particles, positive electrode or cathode material particles. The second mixture may include, as solid-state electroactive material particles, negative electrode or anode material particles. The solid-state electrolyte particles in each instance may be the same or different.

Such solid-state batteries may be incorporated into energy storage devices, like rechargeable lithium-ion batteries, which may be used in automotive transportation applications (e.g., motorcycles, boats, tractors, buses, mobile homes, campers, and tanks). The present technology, however, may also be used in other electrochemical devices, including aerospace components, consumer goods, devices, buildings (e.g., houses, offices, sheds, and warehouses), office equipment and furniture, and industrial equipment machinery, agricultural or farm equipment, or heavy machinery, by way of non-limiting example. In various aspects, the present disclosure provides a rechargeable lithium-ion battery that exhibits high temperature tolerance, as well as improved safety and superior power capability and life performance.

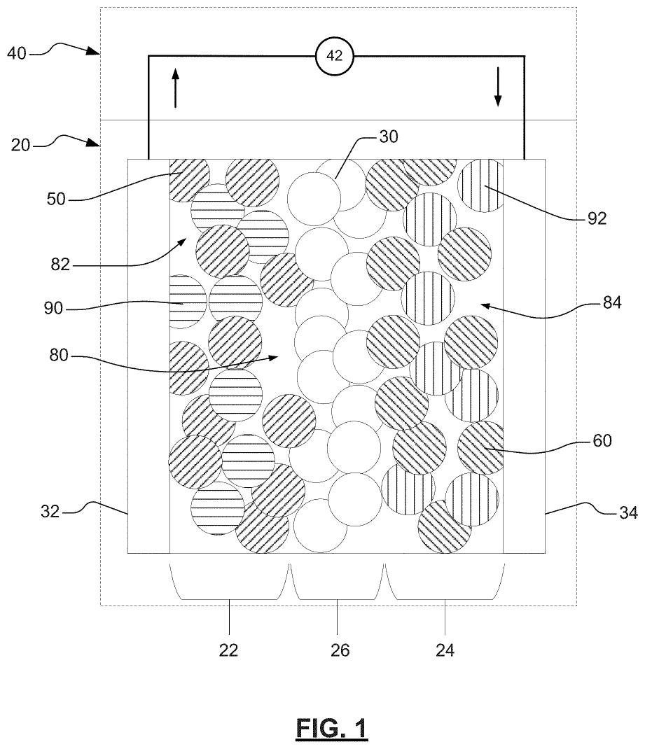

An exemplary and schematic illustration of a solid-state electrochemical cell unit (also referred to as a “solid-state battery” and/or “battery”) 20 that cycles lithium ions is shown in FIG. 1. The battery 20 includes a negative electrode (i.e., anode) 22, a positive electrode (i.e., cathode) 24, and an electrolyte layer 26 that occupies a space defined between the two or more electrodes. The electrolyte layer 26 is a solid-state or semi-solid state separating layer that physically separates the negative electrode 22 from the positive electrode 24. The electrolyte layer 26 may include a first plurality of solid-state electrolyte particles 30. A second plurality of solid-state electrolyte particles 90 may be mixed with negative solid-state electroactive particles 50 in the negative electrode 22, and a third plurality of solid-state electrolyte particles 92 may be mixed with positive solid-state electroactive particles 60 in the positive electrode 24, so as to form a continuous electrolyte network, which may be a continuous lithium-ion conduction network.

A negative electrode current collector 32 may be positioned at or near the negative electrode 22. A positive electrode current collector 34 may be positioned at or near the positive electrode 24. The negative electrode current collector 32 may be formed from copper or any other appropriate electrically conductive material known to those of skill in the art. The positive electrode current collector 34 may be formed from aluminum or any other electrically conductive material known to those of skill in the art. The negative electrode current collector 32 and the positive electrode current collector 34 respectively collect and move free electrons to and from an external circuit 40 (as shown by the block arrows). For example, an interruptible external circuit 40 and a load device 42 may connect the negative electrode 22 (through the negative electrode current collector 32) and the positive electrode 24 (through the positive electrode current collector 34).

The battery 20 can generate an electric current (indicated by arrows in FIG. 1) during discharge by way of reversible electrochemical reactions that occur when the external circuit 40 is closed (to connect the negative electrode 22 and the positive electrode 24) and when the negative electrode 22 has a lower potential than the positive electrode 24. The chemical potential difference between the negative electrode 22 and the positive electrode 24 drives electrons produced by a reaction, for example, the oxidation of intercalated lithium, at the negative electrode 22, through the external circuit 40 toward the positive electrode 24. Lithium ions, which are also produced at the negative electrode 22, are concurrently transferred through the electrolyte layer 26 toward the positive electrode 24. The electrons flow through the external circuit 40 and the lithium ions migrate across the electrolyte layer 26 to the positive electrode 24, where they may be plated, reacted, or intercalated. The electric current passing through the external circuit 40 can be harnessed and directed through the load device 42 (in the direction of the arrows) until the lithium in the negative electrode 22 is depleted and the capacity of the battery 20 is diminished.

The battery 20 can be charged or reenergized at any time by connecting an external power source (e.g., charging device) to the battery 20 to reverse the electrochemical reactions that occur during battery discharge. The external power source that may be used to charge the battery 20 may vary depending on the size, construction, and particular end-use of the battery 20. Some notable and exemplary external power sources include, but are not limited to, an AC-DC converter connected to an AC electrical power grid though a wall outlet and a motor vehicle alternator. The connection of the external power source to the battery 20 promotes a reaction, for example, non-spontaneous oxidation of intercalated lithium, at the positive electrode 24 so that electrons and lithium ions are produced. The electrons, which flow back toward the negative electrode 22 through the external circuit 40, and the lithium ions, which move across the electrolyte layer 26 back toward the negative electrode 22, reunite at the negative electrode 22 and replenish it with lithium for consumption during the next battery discharge cycle. As such, a complete discharging event followed by a complete charging event is considered to be a cycle, where lithium ions are cycled between the positive electrode 24 and the negative electrode 22.

Although the illustrated example includes a single positive electrode 24 and a single negative electrode 22, the skilled artisan will recognize that the current teachings apply to various other configurations, including those having one or more cathodes and one or more anodes, as well as various current collectors and current collector films with electroactive particle layers disposed on or adjacent to or embedded within one or more surfaces thereof. Likewise, it should be recognized that the battery 20 may include a variety of other components that, while not depicted here, are nonetheless known to those of skill in the art. For example, the battery 20 may include a casing, a gasket, terminal caps, and any other conventional components or materials that may be situated within the battery 20, including between or around the negative electrode 22, the positive electrode 24, and/or the solid-state electrolyte 26 layer.

In many configurations, each of the negative electrode current collector 32, the negative electrode 22, the electrolyte layer 26, the positive electrode 24, and the positive electrode current collector 34 are prepared as relatively thin layers (for example, from several microns to a millimeter or less in thickness) and assembled in layers connected in series arrangement to provide a suitable electrical energy, battery voltage and power package, for example, to yield a Series-Connected Elementary Cell Core (“SECC”). In various other instances, the battery 20 may further include electrodes 22, 24 connected in parallel to provide suitable electrical energy, battery voltage, and power for example, to yield a Parallel-Connected Elementary Cell Core (“PECC”).

The size and shape of the battery 20 may vary depending on the particular applications for which it is designed. Battery-powered vehicles and hand-held consumer electronic devices are two examples where the battery 20 would most likely be designed to different size, capacity, voltage, energy, and power-output specifications. The battery 20 may also be connected in series or parallel with other similar lithium-ion cells or batteries to produce a greater voltage output, energy, and power if it is required by the load device 42. The battery 20 can generate an electric current to the load device 42 that can be operatively connected to the external circuit 40. The load device 42 may be fully or partially powered by the electric current passing through the external circuit 40 when the battery 20 is discharging. While the load device 42 may be any number of known electrically-powered devices, a few specific examples of power-consuming load devices include an electric motor for a hybrid vehicle or an all-electric vehicle, a laptop computer, a tablet computer, a cellular phone, and cordless power tools or appliances, by way of non-limiting example. The load device 42 may also be an electricity-generating apparatus that charges the battery 20 for purposes of storing electrical energy.

With renewed reference to FIG. 1, the negative electrode 22 may be formed from a lithium host material that is capable of functioning as a negative terminal of a lithium-ion battery. For example, in certain variations, the negative electrode 22 may be defined by a plurality of the negative solid-state electroactive particles 50. In certain instances, as illustrated, the negative electrode 22 is a composite comprising a mixture of the negative solid-state electroactive particles 50 and the second plurality of solid-state electrolyte particles 90. For example, the negative electrode 22 may include greater than or equal to about 30 wt. % to less than or equal to about 98 wt. %, and in certain aspects, optionally greater than or equal to about 50 wt. % to less than or equal to about 95 wt. %, of the negative solid-state electroactive particles 50 and greater than or equal to about 0 wt. % to less than or equal to about 50 wt. %, and in certain aspects, optionally greater than or equal to about 5 wt. % to less than or equal to about 20 wt. %, of the second plurality of solid-state electrolyte particles 90. Such negative electrodes 22 may have an interparticle porosity 82 between the negative solid-state electroactive particles 50 and/or the second plurality of solid-state electrolyte particles 90 that is greater than or equal to about 0 vol. % to less than or equal to about 50 vol. %.

The second plurality of solid-state electrolyte particles 90 may be the same as or different from the first plurality of solid-state electrolyte particles 30. In certain variations, the negative solid-state electroactive particles 50 may comprise one or more negative electroactive materials, such as graphite, graphene, hard carbon, soft carbon, and carbon nanotubes (CNTs). In other variations, the negative solid-state electroactive particles 50 may be silicon-based comprising, for example, a silicon alloy and/or silicon-graphite mixture. In still other variations, the negative electrode 22 may include a lithium alloy or a lithium metal. In still further variations, the negative electrode 22 may comprise one or more negative electroactive materials, such as lithium titanium oxide (Li₄Ti₅O₁₂), metal oxides (e.g., TiO₂ and/or V₂O₅), metal sulfides (e.g., FeS), transition metals (e.g., tin (Sn)), and other lithium-accepting materials. Thus, the negative solid-state electroactive particles 50 may be selected from the group including, for example only, lithium, graphite, graphene, hard carbon, soft carbon, carbon nanotubes, silicon, silicon-containing alloys, tin-containing alloys, and any combination thereof.

In certain variations, the negative electrode 22 further includes one or more conductive additives and/or binder materials. For example, the negative solid-state electroactive particles 50 (and/or second plurality of solid-state electrolyte particles 90) may be optionally intermingled with one or more electrically conductive materials (not shown) that provide an electron conduction path and/or at least one polymeric binder material (not shown) that improves the structural integrity of the negative electrode 22.

For example, the negative solid-state electroactive particles 50 (and/or second plurality of solid-state electrolyte particles 90) may be optionally intermingled with binders, such as polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The negative electrode 22 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

The positive electrode 24 may be formed from a lithium-based or electroactive material that can undergo lithium intercalation and deintercalation while functioning as the positive terminal of the battery 20. For example, in certain variations, the positive electrode 24 may be defined by a plurality of the positive solid-state electroactive particles 60. In certain instances, as illustrated, the positive electrode 24 is a composite comprising a mixture of the positive solid-state electroactive particles 60 and the third plurality of solid-state electrolyte particles 92. For example, the positive electrode 24 may include greater than or equal to about 30 wt. % to less than or equal to about 98 wt. %, and in certain aspects, optionally greater than or equal to about 50 wt. % to less than or equal to about 95 wt. %, of the positive solid-state electroactive particles 60 and greater than or equal to about 0 wt. % to less than or equal to about 50 wt. %, and in certain aspects, optionally greater than or equal to about 5 wt. % to less than or equal to about 20 wt. %, of the third plurality of solid-state electrolyte particles 92. Such positive electrodes 24 may have an interparticle porosity 84 between the positive solid-state electroactive particles 60 and/or the third plurality of solid-state electrolyte particles 92 that is greater than or equal to about 0 vol. % to less than or equal to about 50 vol. %.

The third plurality of solid-state electrolyte particles 92 may be the same as or different from the first and/or second pluralities of solid-state electrolyte particles 30, 90. In certain variations, the positive electrode 24 may be one of a layered-oxide cathode, a spinel cathode, and a polyanion cathode. For example, in the instances of a layered-oxide cathode (e.g., rock salt layered oxides), the positive solid-state electroactive particles 60 may comprise one or more positive electroactive materials selected from LiCoO₂, LiNiₓMn_{y}Co_{1-x-y}O₂ (where 0≤x≤1 and 0≤y≤1), LiNiₓMn_{y}Al_{1-x-y}O₂ (where 0<x≤1 and 0<y≤1), LiNiₓMn₁₋ₓO₂ (where 0≤x≤1), and Li₁₊ₓMO₂ (where 0≤x≤1) for solid-state lithium-ion batteries. The spinel cathode may include one or more positive electroactive materials, such as LiMn₂O₄ and LiNi_{0.5}Mn_{1.5}O₄. The polyanion cation may include, for example, a phosphate, such as LiFePO₄, LiVPO₄, LiV₂(PO₄)₃, Li₂FePO₄F, Li₃Fe₃(PO₄)₄, or Li₃V₂(PO₄)F₃ for lithium-ion batteries, and/or a silicate, such as LiFeSiO₄ for lithium-ion batteries. In this fashion, in various aspects, the positive solid-state electroactive particles 60 may comprise one or more positive electroactive materials selected from the group consisting of LiCoO₂, LiNiₓMn_{y}Co_{1-x-y}O₂ (where 0≤x≤1 and 0≤y≤1), LiNiₓMn₁₋ₓO₂ (where 0≤x≤1), Li₁₊ₓMO₂ (where 0≤x≤1), LiMn₂O₄, LiNiₓMn_{1.5}O₄, LiFePO₄, LiVPO₄, LiV₂(PO₄)₃, Li₂FePO₄F, Li₃Fe₃(PO₄)₄, Li₃V₂(PO₄)F₃, LiFeSiO₄, and combinations thereof. In certain aspects, the positive solid-state electroactive particles 60 may be coated (for example, by LiNbO₃ and/or Al₂O₃) and/or the positive electroactive material may be doped (for example, by aluminum and/or magnesium).

In certain variations, the positive electrode 24 may further include one or more conductive additives and/or binder materials. For example, the positive solid-state electroactive particles 60 (and/or third plurality of solid-state electrolyte particles 92) may be optionally intermingled with one or more electrically conductive materials (not shown) that provide an electron conduction path and/or at least one polymeric binder material (not shown) that improves the structural integrity of the positive electrode 24.

For example, the positive solid-state electroactive particles 60 (and/or third plurality of solid-state electrolyte particles 92) may be optionally intermingled with binders, like polyvinylidene difluoride (PVDF), polytetrafluoroethylene (PTFE), ethylene propylene diene monomer (EPDM) rubber, nitrile butadiene rubber (NBR), styrene-butadiene rubber (SBR), polyethylene glycol (PEO), and/or lithium polyacrylate (LiPAA) binders. Electrically conductive materials may include, for example, carbon-based materials or a conductive polymer. Carbon-based materials may include, for example, particles of graphite, acetylene black (such as KETCHEN™ black or DENKA™ black), carbon fibers and nanotubes, graphene (such as graphene oxide), carbon black (such as Super P), and the like. Examples of a conductive polymer may include polyaniline, polythiophene, polyacetylene, polypyrrole, and the like. In certain aspects, mixtures of the conductive additives and/or binder materials may be used.

The positive electrode 24 may include greater than or equal to about 0 wt. % to less than or equal to about 30 wt. %, and in certain aspects, optionally greater than or equal to about 2 wt. % to less than or equal to about 10 wt. %, of the one or more electrically conductive additives; and greater than or equal to about 0 wt. % to less than or equal to about 20 wt. %, and in certain aspects, optionally greater than or equal to about 1 wt. % to less than or equal to about 10 wt. %, of the one or more binders.

The solid-state electrolyte layer 26 provides electrical separation—preventing physical contact—between the negative electrode 22 and the positive electrode 24. The solid-state electrolyte layer 26 also provides a minimal resistance path for internal passage of ions. In various aspects, the solid-state electrolyte layer 26 may be defined by a first plurality of solid-state electrolyte particles 30. For example, the solid-state electrolyte layer 26 may be in the form of a layer or a composite that comprises the first plurality of solid-state electrolyte particles 30. The solid-state electrolyte particles 30 may have an average particle diameter greater than or equal to about 0.02 μm to less than or equal to about 20 μm, optionally greater than or equal to about 0.1 μm to less than or equal to about 10 μm, and in certain aspects, optionally greater than or equal to about 0.1 μm to less than or equal to about 1 μm. The solid-state electrolyte layer 26 may be in the form of a layer having a thickness greater than or equal to about 5 μm to less than or equal to about 200 μm, optionally greater than or equal to about 10 μm to less than or equal to about 100 μm, optionally about 40 μm, and in certain aspects, optionally about 30 μm.

The solid-state electrolyte particles 30 may comprise one or more sulfide-based particles, oxide-based particles, metal-doped or aliovalent-substituted oxide particles, nitride-based particles, hydride-based particles, halide-based particles, and borate-based particles.

In certain variations, the oxide-based particles may comprise one or more garnet ceramics, LISICON-type oxides, NASICON-type oxides, and Perovskite type ceramics. For example, the garnet ceramics may be selected from the group consisting of: Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, and combinations thereof. The LISICON-type oxides may be selected from the group consisting of: Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), and combinations thereof. The NASICON-type oxides may be defined by LiMM′(PO₄)₃, where M and M′ are independently selected from Al, Ge, Ti, Sn, Hf, Zr, and La. For example, in certain variations, the NASICON-type oxides may be selected from the group consisting of: Li₁₊ₓAlₓGe₂₋ₓ(PO₄)₃ (LAGP) (where 0≤x≤2), Li_{1.4}Al_{0.4}Ti_{1.6}(PO₄)₃, Li_{1.3}Al_{0.3}Ti_{1.7}(PO₄)₃, LiTi₂(PO₄)₃, LiGeTi(PO₄)₃, LiGe₂(PO₄)₃, LiHf₂(PO₄)₃, and combinations thereof. The Perovskite-type ceramics may be selected from the group consisting of: Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/16}Nb_{3/4}Zr_{1/4}O₃, Li₃ₓLa_{(2/3-x)}TiO₃ (where 0<x<0.25), and combinations thereof.

In certain variations, the metal-doped or aliovalent-substituted oxide particles may include, for example only, aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), and combinations thereof.

In certain variations, the sulfide-based particles may include, for example only, a pseudobinary sulfide, a pseudoternary sulfide, and/or a pseudoquaternary sulfide. Example pseudobinary sulfide systems include Li₂S—P₂S₅ systems (such as, Li₃PS₄, Li₇P₃S₁₁, and Li_{9.6}P₃S₁₂), Li₂S—SnS₂ systems (such as, Li₄SnS₄), Li₂S—SiS₂ systems, Li₂S—GeS₂ systems, Li₂S—B₂S₃ systems, Li₂S—Ga₂S₃ system, Li₂S—P₂S₃ systems, and Li₂S—Al₂S₃ systems. Example pseudoternary sulfide systems include Li₂O—Li₂S—P₂S₅ systems, Li₂S—P₂S₅—P₂O₅ systems, Li₂S—P₂S₅—GeS₂ systems (such as, Li_{3.25}Ge_{0.25}P_{0.75}S₄ and Li₁₀GeP₂S₁₂), Li₂S—P₂S₅—LiX systems (where X is one of F, Cl, Br, and I) (such as, Li₆PS₅Br, Li₆PS₅Cl, L₇P₂S₈I, and Li₄PS₄I), Li₂S—As₂S₅—SnS₂ systems (such as, Li_{3.833}Sn_{0.833}As_{0.166}S₄), Li₂S—P₂S₅—Al₂S₃ systems, Li₂S—LiX—SiS₂ systems (where X is one of F, Cl, Br, and I), 0.4LiI.0.6Li₄SnS₄, and Li₁₁Si₂PS₁₂. Example pseudoquaternary sulfide systems include Li₂O—Li₂S—P₂S₅—P₂O₅ systems, Li_{9.54}Si_{1.74}P_{1.44}S_{11.7}Cl_{0.3}, Li₇P_{2.9}Mn_{0.1}S_{10.7}I_{0.3}, and Li_{10.35}[Sn_{0.27}Si_{1.08}]P_{1.65}S₁₂.

In certain variations, the nitride-based particles may include, for example only, Li₃N, Li₇PN₄, LiSi₂N₃, and combinations thereof, the hydride-based particles may include, for example only, LiBH₄, LiBH₄—LiX (where x=Cl, Br, or I), LiNH₂, Li₂NH, LiBH₄—LiNH₂, Li₃AlH₆, and combinations thereof, the halide-based particles may include, for example only, LiI, Li₃InCl₆, Li₂CdC₁₄, Li₂MgCl₄, LiCdI₄, Li₂ZnI₄, Li₃OCl, Li₃YCl₆, Li₃YBr₆, and combinations thereof; and the borate-based particles may include, for example only, Li₂B₄O₇, Li₂O—B₂O₃—P₂O₅, and combinations thereof.

In various aspects, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1-x)P₂S₅-xLi₂S (where 0.5≤x≤0.7), Li_{3.4}Si_{0.4}P_{0.6} S₄, PLi₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(S_{0.5}Ge_{0.5})P₂S₁₂, Li₁₀(Ge_{0.5}Sn_{0.5})P₂S₁₂, Li₁₀(S_{0.5}Sn_{0.5})P₂S₁₂, Li_{3.833}Sn_{0.833}As_{0.16}S₄, Li₇La₃Zr₂O₁₂, Li_{6.2}Ga_{0.3}La_{2.95}Rb_{0.05}Zr₂O₁₂, Li_{6.85}La_{2.9}Ca_{0.1}Zr_{1.75}Nb_{0.25}O₁₂, Li_{6.25}Al_{0.25}La₃Zr₂O₁₂, Li_{6.75}La₃Zr_{1.75}Nb_{0.25}O₁₂, Li_{6.75}La₃Zr_{1.75}Nb_{0.25}O₁₂, Li₂₊₂ₓZn₁₋ₓGeO₄ (where 0<x<1), Li₁₄Zn(GeO₄)₄, Li₃₊ₓ(P₁₋ₓSiₓ)O₄ (where 0<x<1), Li₃₊ₓGeₓV₁₋ₓO₄ (where 0<x<1), LiMM′(PO₄)₃ (where M and M′ are independently selected from Al, Ge, Ti, Sn, Hf, Zr, and La), Li_{3.3}La_{0.53}TiO₃, LiSr_{1.65}Zr_{1.3}Ta_{1.7}O₉, Li_{2x-y}Sr₁₋ₓTa_{y}Zr_{1-y}O₃ (where x=0.75y and 0.60<y<0.75), Li_{3/8}Sr_{7/6}Nb_{3/4}Zr_{1/4}O₃, Li₃ₓLa_{(2/3-x)}TiO₃ (where 0<x<0.25), aluminum (Al) or niobium (Nb) doped Li₇La₃Zr₂O₁₂, antimony (Sb) doped Li₇La₃Zr₂O₁₂, gallium (Ga) doped Li₇La₃Zr₂O₁₂, chromium (Cr) and/or vanadium (V) substituted LiSn₂P₃O₁₂, aluminum (Al) substituted Li_{1+x+y}AlₓTi₂₋ₓSi_{Y}P_{3-y}O₁₂ (where 0<x<2 and 0<y<3), LiI—Li₄SnS₄, Li₄SnS₄, Li₃N, Li₇PN₄, LiSi₂N₃, LiBH₄, LiBH₄—LiX (where x=Cl, Br, or I), LiNH₂, Li₂NH, LiBH₄—LiNH₂, Li₃AlH₆, LiI, Li₃InCl₆, Li₂CdC₁₄, Li₂MgCl₄, LiCdI₄, Li₂ZnI₄, Li₃OCl, Li₂B₄O₇, Li₂O—B₂O₃—P₂O₅, and combinations thereof.

In certain variations, the first plurality of solid-state electrolyte particles 30 may include one or more electrolyte materials selected from the group consisting of: Li₂S—P₂S₅ system, Li₂S—P₂S₅-MOₓ system (where 1<x<7), Li₂S—P₂S₅-MSₓ system (where 1<x<7), Li₁₀GeP₂S₁₂ (LGPS), Li₆PS₅X (where X is Cl, Br, or I) (lithium argyrodite), Li₇P₂S₈I, Li_{10.35}Ge_{1.35}P_{1.65}S₁₂, Li_{3.25}Ge_{0.25}P_{0.75}S₄ (thio-LISICON), Li₁₀SnP₂S₁₂, Li₁₀SiP₂S₁₂, Li_{9.54}Si_{1.74}P_{1.44}S_{11.7}Cl_{0.3}, (1-x)P₂S₅-xLi₂S (where 0.5≤x≤0.7), Li_{3.4}Si_{0.4}P_{0.6} S₄, PL₁₀GeP₂S_{11.7}O_{0.3}, Li_{9.6}P₃S₁₂, Li₇P₃S₁₁, Li₉P₃S₉O₃, Li_{10.35}Ge_{1.35}P_{1.63}S₁₂, Li_{9.81}Sn_{0.81}P_{2.19}S₁₂, Li₁₀(S_{10.5}Ge_{0.5})P₂S₁₂, Li₁₀(Ge_{0.5}Sn_{0.5})P₂S₁₂, Li₁₀(Si_{0.5}Sn_{0.5})P₂S₁₂, Li_{3.833}Sn_{0.833}As_{0.16}S₄, and combinations thereof.

Although not illustrated, the skilled artisan will recognize that in certain instances, one or more binder particles may be mixed with the solid-state electrolyte particles 30. For example, in certain aspects the solid-state electrolyte layer 26 may include greater than or equal to about 0 wt. % to less than or equal to about 10 wt. %, and in certain aspects, optionally greater than or equal to about 0.5 wt. % to less than or equal to about 10 wt. %, of the one or more binders. The one or more polymeric binders may include, for example only, polyvinylidene difluoride (PVDF), polytetrafluoroethylene (PTFE), ethylene propylene diene monomer (EPDM) rubber, nitrile butadiene rubber (NBR), styrene-butadiene rubber (SBR), and lithium polyacrylate (LiPAA).

In certain instances, the solid-state electrolyte particles 30 (and the optionally one or more binder particles) may be wetted by a small amount of liquid electrolyte, for example, to improve ionic conduction between the solid-state electrolyte particles 30. The solid-state electrolyte particles 30 may be wetted by greater than or equal to about 0 wt. % to less than or equal to about 40 wt. %, optionally greater than or equal to about 0.1 wt. % to less than or equal to about 40 wt. %, and in certain aspects, optionally greater than or equal to about 5 wt. % to less or equal to about 10 wt. %, of the liquid electrolyte, based on the weight of the solid-state electrolyte particles 30. In certain variations, Li₇P₃S₁₁ may be wetted by an ionic liquid electrolyte including LiTFSI-triethylene glycol dimethyl ether.

In various aspects, the present disclosure provides a method for forming a solid-state electrolyte layer, such as the solid-state electrolyte layer 26 illustrated in FIG. 1. As detailed above, a solid-state electrolyte layer often includes a plurality of solid-state electrolyte particles. The solid-state electrolyte layer may be formed, for example, by sintering the solid-state electrolyte particles to form a bulk form that defines the solid-state electrolyte layer. In certain variations, forming the solid-state electrolyte may include various processes, such as sintering, extrusion, vapor deposition, and/or hot press. In each instance, the bulk form may have a minimum porosity, for example, the solid-state electrolyte layer may have a porosity greater than or equal to about 0 vol. % to less than or equal to about 30 vol. %.

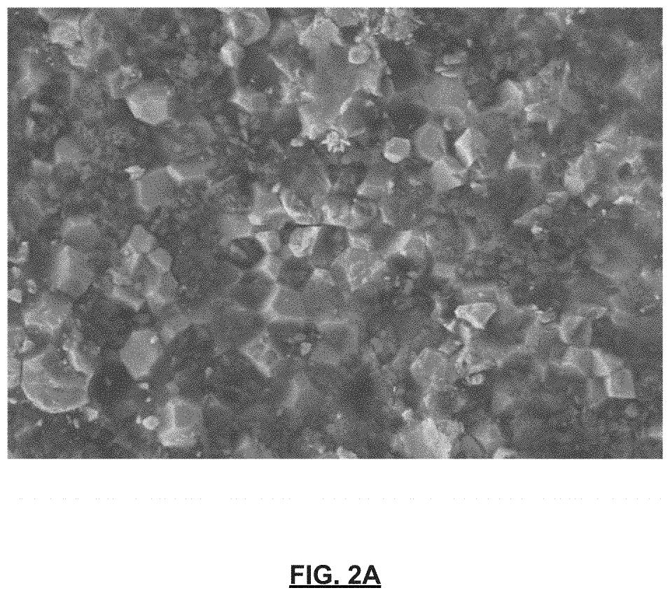

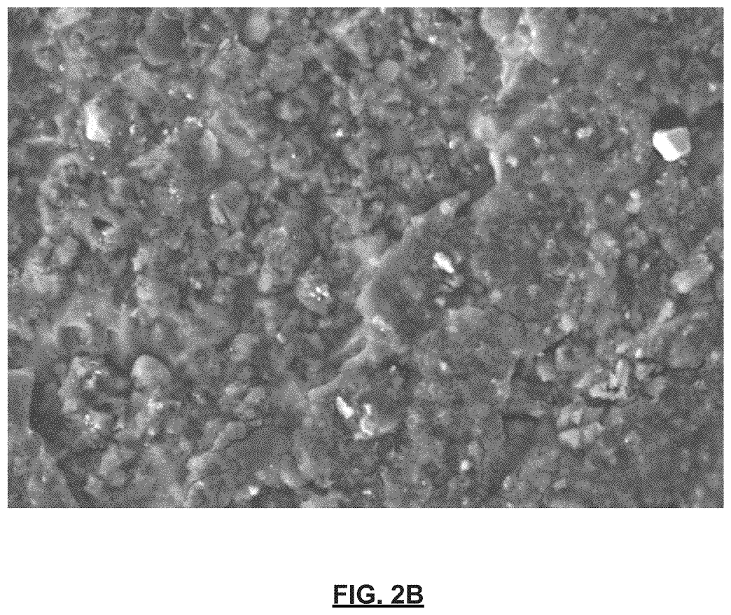

Certain solid-state electrolyte particles, and solid-state electrolyte layers formed therefrom, such as lithium lanthanum zirconium oxide (Li₇La₃Ze₂O₁₂) (LLZO), Li₂S—P₂S₅ system, Li₂S—P₂S₅-MOx system, and/or halide perovskite electrolytes, may have one or more air-sensitive surfaces, such that over time a passivation layer is formed on the one or more air-sensitive surfaces of the solid-state electrolyte layer. For example, certain solid-state electrolyte particles, and solid-state electrolyte layers formed therefrom, may be sensitive to oxygen, moisture (water), and/or carbon dioxide. The passivation layer may result from the reaction of lithium with water and carbon dioxide that can be present during the manufacturing and storage of the solid-state electrolyte layer, and also, subsequently during cell fabrication. For example, FIG. 2A is a scanning electron microscope image of a clean solid-state electrolyte layer, while FIG. 2B is a scanning electron microscope image of the same solid-state electrolyte layer after overnight exposure to the environment. In certain variations, the passivation layer may include lithium carbonate (Li₂CO₃), for example as a result of 2Li+2H₂O→2LiOH+H₂, 2LiOH+CO₂→Li₂CO₃+H₂O.

The passivation layer increases interfacial impendence in the cell, and also impacts the wettability of the negative electroactive material (e.g., lithium metal), such that establishing and maintaining contact between the solid-state electrolyte layer and the negative electrode is negatively impacted. For example, a solid-state electrolyte layer including a passivation layer may have a comparatively high contact angle (e.g., about 146°), while a solid-state electrolyte layer free of a passivation layer may have a comparatively low contact angle (e.g., about 95°).

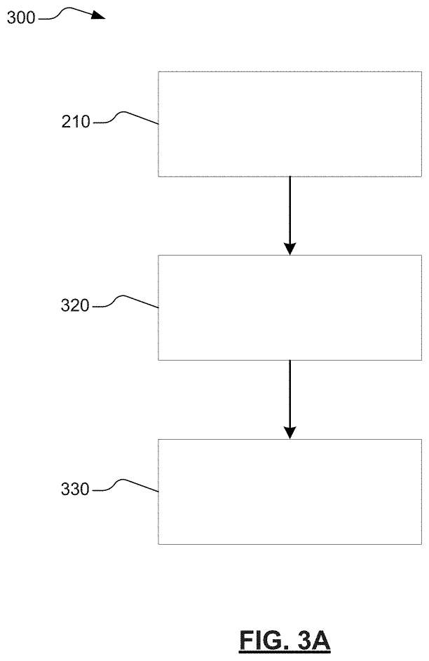

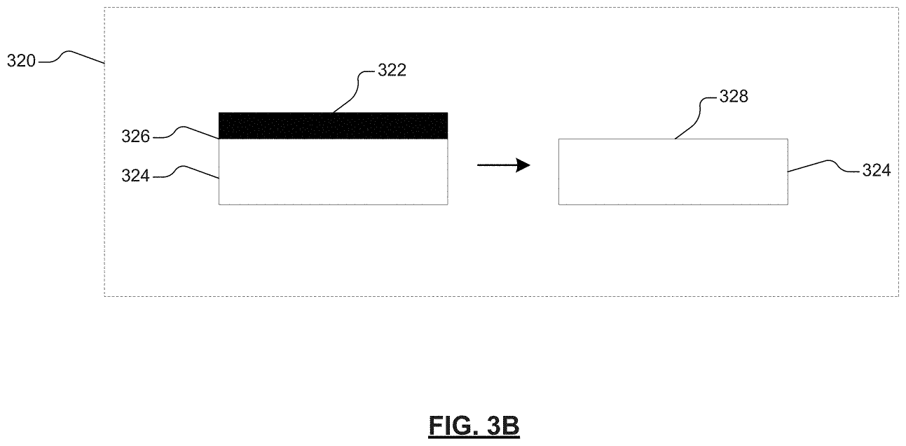

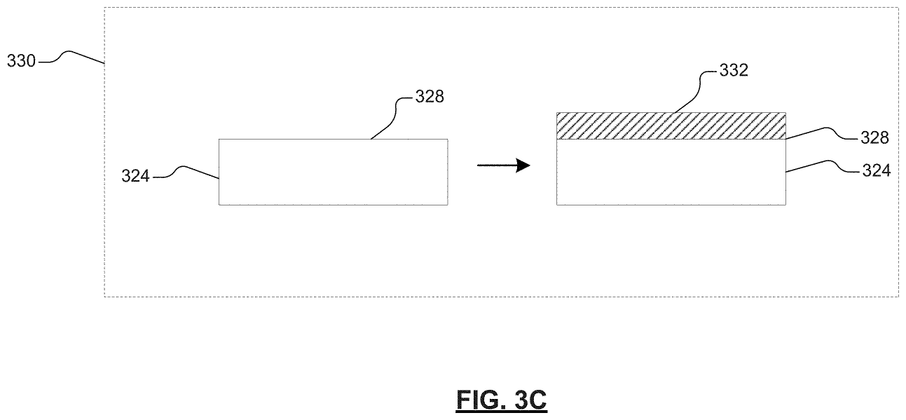

In various aspects, the present disclosure provides a method for restoring a solid-state electrolyte layer having one or more passivation layers formed on one or more surfaces thereof. The method includes using a laser surface treatment process or a plasma surface treatment process to remove the passivation layer. Removal of the passivation layer may reduce interfacial impendence and improve the wettability of the negative electroactive material (e.g., lithium metal) to the solid-state electrolyte layer (e.g., lithium lanthanum zirconium oxide (Li₇La₃Ze₂O₁₂) (LLZO)). An example method 300 for restoring a solid-state electrolyte layer is illustrated in FIGS. 3A-3C.

The method 300 includes removing 320 a passivation layer 322 from a surface 326 of a solid-state electrolyte layer 324 using a laser surface treatment process or a plasma surface treatment process. In various aspects, the laser surface treatment process may use a laser scanner to focus light locally to heat the passivation layer 322. For example, the laser scanner may be a galvanometer optical scanner including two motorized mirrors that are able to quickly rotate to reflect the laser beam in both the X and Y directions. The laser scanner may be a highly dynamic electro-optical component that uses rotatable mirrors to position a laser beam in a two-dimensional geometry with high precision and repeatability. The laser scanner may have a comparatively high laser scanning speed for manufacturing throughput (e.g., less than a few meters per second). In various aspects, the plasma surface treatment process may use ionized gas (such as, oxygen or argon) to bombard and heat the passivation layer 322.

In each instance, the localized heating may decompose the passivation layer 322, for example, by thermal vaporization or laser-induced decomposition, such that when the passivation layer 322 includes lithium carbonate (Li₂CO₃), the lithium carbonate (Li₂CO₃) becomes Li₂O and CO₂. In certain variations, the localized heating may cause a volumetric expansion of the passivation layer 322 such that a thermal mismatch is formed between the passivation layer 322 and the solid-state electrolyte layer 324 allowing for easy peeling of the passivation layer 322 away from the solid-state electrolyte layer 324. In still other variations, where the passivation layer is comparatively thin (e.g., greater than or equal to about 20 nm to less than or equal to about 2 μm), the laser or plasma may be mostly transmitted through the passivation layer 322 and localized heating or thermal stress at the interface may cause the passivation layer 322 to break away from the solid-state electrolyte layer 324.

In each instance, removing 320 the passivation layer 322 may occur in an inert atmosphere, including for example, nitrogen (N₂) and/or argon (Ar). In other variations, removing 320 the passivation layer 322 may occur in an open environment, when the removing 320 process has a duration of less than or equal to about 24 hours, such that the solid-state electrolyte layer 324 does not significantly react with the environment.

In each instance, removing 320 the passivation layer 322 exposes one or more unpassivated surface regions of a surface 328 of the solid-state electrolyte layer 324. For example, removing 320 the passivation layer 322 may remove greater than or equal to about 90%, optionally greater than or equal to about 95%, optionally greater than or equal to about 96%, optionally greater than or equal to about 97%, optionally greater than or equal to about 98%, optionally greater than or equal to about 99%, and in certain aspects, optionally greater than or equal to about 99.5%, of the total surface area of the passivation layer 322. Although the present examples detail removing 320 a passivation layer from a single surface of a solid-state electrolyte layer, the skilled artisan will understand that similar treatments or processes may be applied to one or more other surfaces of the solid-state electrolyte layer and one or more other passivation layers formed thereon.

In various aspects, the method 300 may include selecting 310 the operating parameters for the laser scanner or plasma scanner, such that the laser scanner or plasma scanner is configured to remove the passivation layer 322 without thermal damage to the solid-state electrolyte layer 324. For example, the laser scanner or plasma scanner may be adapted or selected 310 so to have a processing temperature (i.e., heat induced by the laser scanner or the plasma scanner) that is greater than the decompose temperature of the passivation layer 322. In certain variations, such as when the passivation layer 322 includes lithium carbonate (Li₂CO₃), the laser scanner or plasma scanner may be configured to have a processing temperature of about 1310° C., when the decompose temperature of the lithium carbonate (Li₂CO₃) is about 1300° C.

In certain variations, the laser scanner may also be adapted or selected 310 so to have a power greater than or equal to about 300 W to less than or equal to about 1,000 W, and in certain aspects, optionally about 600 W. The laser scanner may also be adapted or selected 310 so to have a scan speed greater than or equal to about 1 m/s to less than or equal to about 5 m/s, and in certain aspects, optionally about 1.5 m/s. Selecting 310 the laser scanner so to have a power greater than or equal to about 300 W to less than or equal to about 1,000 W and a scan speed greater than or equal to about 1 m/s to less than or equal to about 5 m/s may help to avoid or reduce excessive heating during the removing 320 process and phase transformation of the solid-state electrolyte layer 324. In certain variations, at least a portion of the newly exposed surface 328 of the solid-state electrolyte layer 324 may be partially melted at the grain boundaries so to induce compressive stress and to help to reduce dendrite penetration through the solid-state electrolyte layer 324. In certain variations, for mass production, a higher power and a higher speed may be selected, and for higher quality removal, a lower power and a lower speed may be selected.

The laser scanner may also be adapted or selected 310 so to have a wavelength that can be absorbed by the passivation layer 322. For example, in certain variations, such as when the passivation layer 322 includes lithium carbonate (Li₂CO₃), the laser scanner may have a wavelength of about 1070 nm. The laser scanner may also be adapted or selected 310 so to have a spot size greater than or equal to about 50 μm to less than or equal to about 1,000 μm, and in certain aspects, optionally about 200 μm.

In various aspects, the method 300 may include disposing 330 a protective coating 332 on the newly exposed surface 328 of the solid-state electrolyte layer 324. The protective coating 332 may be a substantially continuous coating having a thickness greater than or equal to about 5 nm to less than or equal to about (5 μm and covering greater than or equal to about 90%, optionally greater than or equal to about 92%, optionally greater than or equal to about 95%, optionally greater than or equal to about 97%, optionally greater than or equal to about 98%, optionally greater than or equal to about 99%, or in certain aspects, optionally greater than or equal to about 99.5%, of a the newly exposed surface 328 of the solid-state electrolyte layer 324. The protective coating 332 may include, for example, gold (Au), silver (Ag), aluminum (Al), lithium phosphorus oxynitride (LiPON), lithium phosphate (Li₃PO₄), lithium nitride (Li₃N), conductive polymers (such as, polyethylene oxide), and the like. The protective coating 332 may be disposed using a laser ablation process, a sputtering process, an e-beam evaporation process, an atomic layer disposition process, or the like. In each instance, the protective coating 332 may help to further protect the solid-state electrolyte layer 324, while also reducing interfacial impedance. For example, the protective coating 332 may prevent the formation of a new passivation layer. The protective coating 332 may be conductive to lithium ions, so to reduce the interfacial impedance. For example, the protective coating 332 may have an ionic conductivity greater than or equal to about 1 S·cm⁻¹ to less than or equal to about 1×10⁻⁸ S·cm⁻¹.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for restoring a solid-state electrolyte layer having one or more passivation layers formed on one or more surfaces thereof, the method comprising:
exposing one or more surface regions of the solid-state electrolyte layer by removing the one or more passivation layers using a surface treatment process that comprises heating at least one portion of the one or more passivation layers or an interface between the solid-state electrolyte layer and the one or more passivation layers to a temperature that is at least 5% greater than a decomposition temperature of the one or more passivation layers.

2. The method of claim 1, wherein the surface treatment process is a thermal vaporization process.

3. The method of claim 1, wherein the surface treatment process comprises heating the interface between the solid-state electrolyte layer and the one or more passivation layers such that thermal stress causes the one or more passivation layers to break away from the solid-state electrolyte layer.

4. The method of claim 1, wherein the surface treatment process comprises heating the at least one portion of the one or more passivation layers so as to cause volumetric expansion of the one or more passivation layers, and the method further comprises peeling the one or more passivation layers away from the one or more surface regions of the solid-state electrolyte layer.

5. The method of claim 1, wherein the surface treatment process uses a laser scanner that transmits light having a power of greater than or equal to about 300 W to less than or equal to about 1,000 W, and the surface treatment process has a scan speed for transmitting light that is greater than or equal to about 1 m/s to less than or equal to about 5 m/s.

6. The method of claim 1, wherein the surface treatments process has a spot size that is greater than or equal to about 100 nm to less than or equal to about 10 μm.

7. The method of claim 1, wherein the surface treatment process uses a plasma treatment process.

8. The method of claim 1, wherein the removing occurs in an inert atmosphere.

9. The method of claim 1, wherein the removing occurs within a period of less than or equal to about 24 hours and occurs in an open environment.

10. The method of claim 1, further comprising:
disposing a protective layer on the one or more surface regions of the solid-state electrolyte layer.

11. The method of claim 10, wherein the protective layer is a substantially continuous coating having a thickness of greater than or equal to about 5 nm to less than or equal to about 5 μm and an ionic conductivity of greater than or equal to about 1 S·cm⁻¹ to less than or equal to about 1×10⁻⁸ S·cm⁻¹.

12. The method of claim 10, wherein the protective layer comprises one or more materials selected from the group consisting of: gold (Au), silver (Ag), aluminum (Al), lithium phosphorus oxynitride (LiPON), lithium phosphate (Li₃PO₄), lithium nitride (Li₃N), polyethylene oxide (PEO), and combinations thereof.

13. The method of claim 1, the method further comprising prior to the exposing:
sintering a plurality of solid-state electrolyte particles to form the solid-state electrolyte layer, wherein the one or more passivation layers are formed on the one or more surfaces of the solid-state electrolyte layer when exposed to at least one of water and carbon dioxide.

14. The method of claim 1, wherein the one or more passivation layers comprise lithium carbonate (Li₂CO₃) and the solid-state electrolyte layer comprises lithium lanthanum zirconium oxide (Li₇La₃Ze₂O₁₂) (LLZO).

15. A method for forming a solid-state electrolyte layer, the method comprising:
treating a surface of a solid-state electrolyte precursor, wherein the solid-state electrolyte precursor comprises a solid-state electrolyte layer and one or more passivation layers formed on one or more surfaces thereof, and wherein the treating comprises removing the one or more passivation layers from the solid-state electrolyte precursor to expose one or more surface regions of the solid-state electrolyte surface; and
disposing a protective layer on at least one of the one or more surface regions of the solid-state electrolyte layer, wherein the protective layer is a substantially continuous coating having a thickness greater than or equal to about 5 nm to less than or equal to about 5 μm and an ionic conductivity greater than or equal to about 1 S·cm⁻¹ to less than or equal to about 1×10⁻⁸ S·cm⁻¹.

16. The method of claim 15, wherein the one or more passivation layers are removed from the solid-state electrolyte precursor by using one of a laser surface treatment process or a plasma surface treatment process,
wherein the laser surface treatment process or the plasma surface treatment process heats at least a portion of the one or more passivation layers to a temperature that is at least 5% greater than a decomposition temperature of the one or more passivation layers.

17. The method of claim 15, wherein the treating of the surface of the solid-state electrolyte precursor comprises heating the interface between the solid-state electrolyte layer and the one or more passivation layers such that thermal stress causes the one or more passivation layers break away from the solid-state electrolyte layer.

18. The method of claim 15, wherein the treating the surface of the solid-state electrolyte precursor comprises heating at least one portion of the one or more passivation layers so to cause volumetric expansion of the one or more passivation layers, and the method further comprises peeling the one or more passivation layers away from the one or more surface regions of the solid-state electrolyte layer.

19. The method of claim 15, wherein the treating occurs in an inert atmosphere.

20. The method of claim 15, wherein the treating occurs within a period less than or equal to about 24 hours and occurs in an open environment.
